(19) United States
(12) Patent Application Publication
(10) Pub. No.: US 2008/0005245 A1
(43) Pub. Date: Jan. 3, 2008

(54) Conferencing system with firewall

(76) Inventors: Scott Deboy, Hillsboro, OR (US); Kenneth Majors, Lake Oswego, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/824,095

(22) Filed: Jun. 29, 2007

Related U.S. Application Data
(60) Provisional application No. 60/818,166, filed on Jun. 30, 2006.

(51) Int. Cl. G06F 15/16

(52) U.S. Cl. 709/204

(57) ABSTRACT

A conferencing system with at least one user and a conferencing server where the firewalls of the user are selected to use port 80.

### CROSS-REFERENCE TO RELATED APPLICATIONS

This application claims the benefit of 60/816,166 filed Jun. 30, 2006.

### BACKGROUND OF THE INVENTION

The present invention relates to a conferencing system and, more particularly, to a computer-based conferencing system enabling effective use through one or more firewalls.

Many business activities are performed by teams of individuals that may be widely dispersed geographically. For example, product design and manufacturing are commonly performed by teams having members who are often located in facilities spread around the globe and/or who may be in transit between locations. If a decision is to be made concerning the project it may be necessary to quickly gather input and consensus from the members of the team regardless of their physical remoteness. Modern communication technology enables individuals to communicate over long distances and from remote locations. Conferencing systems facilitate communication between a plurality of remotely located users or conferees by allowing multiple users to communicatively interconnect with each other either directly as peers or by interconnecting with a central server that is interconnected to the other participants in the conference. Computer-based conferencing systems commonly provide for audio and video input from each of the conferees. In addition, a conferencing system may provide file sharing enabling conferees to view and edit files, including engineering drawings and spreadsheets, that are part of the team's project.

One goal of a conferencing system is to connect a plurality of remotely located conferees and enable communication between the conferees as if the conferees were sitting at the same conference table. Within each organization, typically at the interconnection between the local area network and the Internet (or wide area network) a firewall is installed through which goes the network based traffic. Unfortunately, the configuration of the firewall to facilitate all the different types of network traffic tends to be burdensome.

### BRIEF DESCRIPTION OF THE SEVERAL VIEWS OF THE DRAWINGS

FIG. 1 illustrates a set of users.

FIG. 2 illustrates a set of users and a conferencing server.

FIG. 3 illustrates a routing table on the conferencing server for a set of users.

### DETAILED DESCRIPTION OF PREFERRED EMBODIMENT

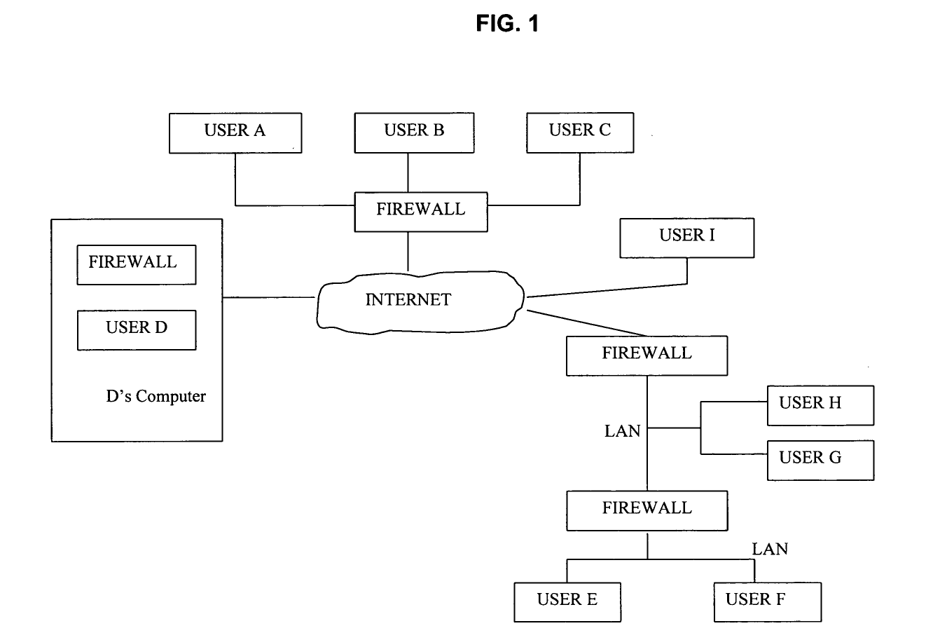

Referring to FIG. 1, a plurality of users may be interconnected to one another through a computer network. For example, users A, B, and C may be interconnected to one another by a local area network. Typically, the users A, B, and C may provide data to another within the local area network without significant security related issues. The users A, B, and C may provide their data communications to other users through the associated firewall to the Internet.

The user D may be connected through an associated firewall within his computer (hardware and/or software) to the Internet. The users E and F may interconnected through a firewall to users H and G, all of which are interconnected to the Internet by an associated firewall. User I may be interconnected to the Internet directly without a firewall. Depending upon the configuration, the firewall may be a dedicated hardware firewall, a software based firewall operating on a general purpose computer, or otherwise a firewall program operating on the user's computer.

Different types of data are transmitted and received through different logical ports on the computer and/or firewall. For example, some common ports on the firewall that are used for audio and/or video and/or data sharing conferences are as follows:
1719 Static UDP Gatekeeper RAS
1720 Static TCP Q.931 (Call Setup)
1024-65535 Dynamic TCP H.245(Call Parameters)
1024-65535 Dynamic UDP (RTP) Video Data Streams
1024-65535 Dynamic UDP (RTP) Audio Data Streams
1024-65535 Dynamic UDP (RTCP) Control Information
389 Static TCP ILS Registration (LDAP)
1002 Static TCP Site Server Registration (Windows 2000 Built-in LDAP)
1503 Static TCP T.120 (Data Channel)
1718 Static UDP Gatekeeper Discovery (requires multicast address 224.0.1.41)
22136 Static TCP Emblaze-VCON MXM—Remote Emblaze—VCON Endpoint Admin
26505 Static TCP Emblaze-VCON MXM—Remote Console Login
   Other ports may be used depending on the particular technology and its implementation. In order to facilitate this configuration, the administrator of the firewall may choose to open all inward bound and outward bound network traffic on all ports of the firewall to all data types. In this manner, no matter which ports are used by the conferencing software all the data traffic will be permitted. Unfortunately, opening up all the inward bound and outward bound traffic on all ports of the firewall results in undesirable security vulnerability to the network and/or computer.

Another configuration to facilitate the exchange of network traffic is to permit the outward bound traffic to be on any port and only permit inward bound traffic on specific ports. This results in greater network security than permitting all inbound and outbound traffic. However, this still requires the administrator of the firewall to manage which ports to permit data traffic on. In addition, the administrator for the firewall may need to select which particular programs are permitted to use any particular port. All of this configuration is burdensome for the administrator of the firewall.

In some cases, the firewall administrator may specify specific ports over which the network traffic may be provided together with providing state inspection of each packet (or some packets) being received and/or transmitted over the ports. For example, if a video packet is suppose to be received inward through port 1024, then the firewall can ensure that the contents of each packet on port 1024 are in fact video packets. For example, if a video packet is suppose to be transmitted through port 1024, then the firewall can ensure that the contents of each packet on port 1024 are in fact video packets. In this manner, the administrator of the firewall can ensure that only the desired type of packets are received and/or transmitted on any particular port. While such packet inspection are useful to increase network security, this requires considerable effort on the part of the firewall administrator. Moreover, with multiple firewalls present in any particular network, the configuration of each firewall for a particular conferencing system in a manner that maintains network security while permitting the transmission of suitable data streams, require significant configuration by the firewall administrator.

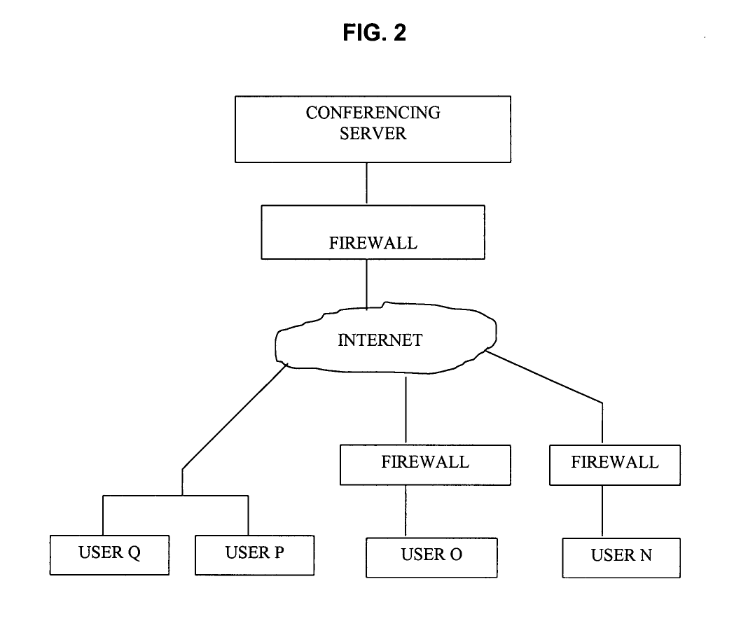

Referring to FIG. 2, the system may alleviate the firewall configuration issues by including a conferencing server interconnected to the other users through a network or the Internet. Typically the conferencing server is interconnected to the Internet through a firewall. For any particular network environment, there is normally only a very limited number of conferencing servers, especially in comparison to the number of users. However, the conferencing server's firewall is typically controlled by the administrator of the conferencing server, and thus may be configured to permit all appropriate conferencing system data streams. In this manner, the conferencing server's firewall is typically configured in a manner which does not impede the ability to effectively transmit and receive conferencing related data streams to the Internet.

The users N, O, P, Q may likewise be interconnected to the Internet through an associated network and/or firewall. Typically, most if not all, firewalls have Internet browsing capability for outbound data traffic open and inbound data traffic open by default. The typical firewall port for such communications is port 80. Thus, if user N, O, P, and Q use port 80 for all of the conferencing communications then the user N will not likely need to do further firewall configurations. The conferencing communications typically include an audio stream, a video stream, and/or a data sharing stream.

In order to start a conferencing session, preferably the user N initiates a socket connection request to the conferencing server. This request is initiated over port 80 from the user N to the conferencing server. The request is received by the conferencing server, which in turn, validates the user N as being authorized to join conferences on the conferencing server. The conferencing server, in response to receiving the request, provides data back to user N using port 80. Thus the traffic through the user's firewall is on port 80.

In some cases, firewalls are designed to permit incoming data traffic, such as those on port 80, when the session was initiated by outgoing data traffic from the user N. Otherwise, some firewalls will tend to block incoming data traffic, even on port 80, for security reasons. Accordingly, by the user N initiating the session using port 80 and in response receives incoming data on port 80, firewalls with this initiation security protocol will likewise permit data traffic.

In order to facilitate a video conferencing session, the conferencing server sends and/or receives video data to or from the user N. In addition, the conferencing server sends and/or receives audio data to or from the user N. Also, the conferencing server sends and/or receives data to or form the user N. In the event that the conferencing server facilitates chat messages (e.g., SMS), the conferencing server sends and/or receives text messages to or from the user N. Moreover, there may be data services and/or configuration communications that likewise are desirable to be transmitted to and from the user N. Unfortunately, each of these communications are typically transmitted and received using different ports on the firewall.

To permit the conferencing server to effectively communicate with the user N (and other users) the video packets, and/or audio packets, and/or chat packets, and/or data services, and/or configuration communication (or other types of data), the conferencing server packets all of the data packets to be transmitted and received over port 80, namely, within the type of packets used for Internet based web browsing. The user N transmits and receives packets over port 80 by having a program installed on the local computer, a program operating in a browser environment such as a JAVA program, or otherwise any program which transmits and receives the packets over port 80. The packets are then processed to obtain the video data, and/or the audio data, and/or the chat data, and/or any other data being received in order to render the video streams, audio streams, data, and/or data services to the user N.

Similarly, to permit the user N to effectively communicate with the conferencing server(s) the video packets, and/or audio packets, and/or chat packets, and/or data services, and/or configuration communication, the packets are all provided in data packets over port 80. The data packets are then processed to obtain the video data, and/or audio data, and/or chat data, and/or any other data being received.

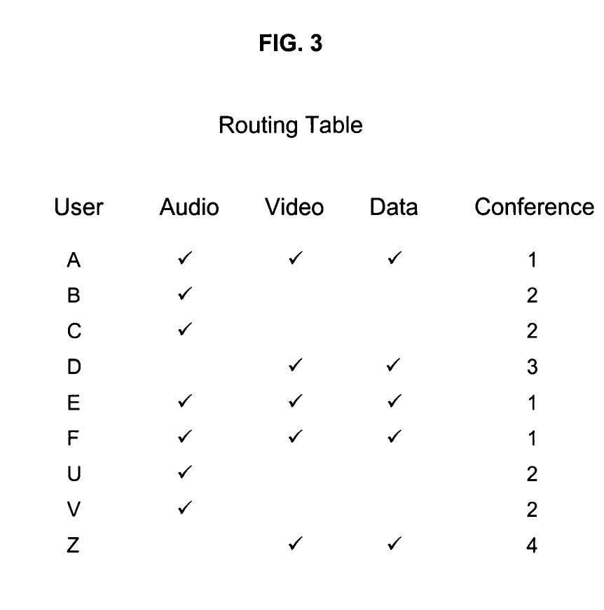

The conferencing server has a routing table that defines the users that should receive the audio/video/data/chat/desktop/etc. feeds, as illustrated in FIG. 3. The data may be for which services the conferencing server will accept from a user and which serves the conferencing server will provide to a user. Also, the routing table indicates the conferences to which the data streams should be provided to by the server. For example, the data feeds from users B, C, U, and V should be shared among one another for an audio conference.

1. A conferencing system comprising:
(a) a first user of said conferencing system that selectively transmits a video stream, an audio stream, and a data stream to a conferencing server;
(b) a first user firewall associated with said first user that receives and then transmits said video stream on port 80 of said first user firewall from said first user, said audio stream on port 80 of said first user firewall from said first user, and said data stream on port 80 of said first user firewall from said first user;
(c) a conferencing firewall associated with said conferencing server that receives and then transmits said video stream on port 80 of said conferencing firewall from said first user firewall, said audio stream on port 80 of said conferencing firewall from said first user firewall, and said data stream on port 80 of said conferencing firewall from said first user firewall;
(d) said conferencing server receiving said video stream from said conferencing firewall, said audio stream from said conferencing firewall, and said data stream from said conferencing firewall;
(e) said conferencing server transmitting said video stream, said audio stream, and said data stream to a second user;
(f) said conferencing firewall associated with said conferencing firewall that receives and then transmits said video stream on port 80 of said conferencing firewall from said conferencing system, said audio stream on port 80 of said conferencing firewall from said conferencing system, and said data stream on port 80 of said conferencing firewall from said conferencing system;
(g) a second user firewall associated with said second user that receives and then transmits said video stream on port 80 of said second user firewall from said conferencing firewall to said second user, said audio stream on port 80 of said second user firewall from said conferencing firewall to said second user, and said data stream on port 80 of said second user firewall from said second user to said second user;
(h) said second user of said conferencing system receives said video stream, said audio stream, and said data stream from said second user firewall.
